(19) United States
(12) Patent Application Publication
(10) Pub. No.: US 2008/0260288 A1
(43) Pub. Date: Oct. 23, 2008

(54) Creating a Depth Map

(75) Inventor: Peter-Andre Redert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,564

(22) PCT Filed: Jan. 24, 2005
(86) PCT No.: PCT/IB05/50269

§ 371 Date: Jul. 31, 2006

(30) Foreign Application Priority Data
Feb. 3, 2004 (EP) 04100384.9

(51) Int. Cl. G06K 9/36

(52) U.S. Cl. 382/285

(57) ABSTRACT

A method of generating a depth map (106) comprising depth values representing distances to a viewer, for respective pixels of an image (100), is disclosed. The method comprises: segmenting the image (100) into a first segment (110) and a second segment (108); and assigning a first one of the depth values corresponding to a first one of the pixels of the first segment (110) on basis of a first size of the first segment (110) and assigning a second one of the depth values corresponding to a second one of pixels of the second segment (108) on basis of a second size of the second segment (108) whereby the first one of the depth values is less than the second one of the depth values if the first size is less than the second size.

The invention relates to a method of generating a depth map comprising depth values representing distances to a viewer, for respective pixels of an image.

The invention further relates to a depth map generating unit for generating a depth map comprising depth values representing distances to a viewer, for respective pixels of an image.

The invention further relates to an image processing apparatus comprising:

receiving means for receiving a signal corresponding to an image; and

such a depth map generating unit for generating a depth map.

The invention further relates to a computer program product to be loaded by a computer arrangement, comprising instructions to generate a depth map comprising depth values representing distances to a viewer, for respective pixels of an image, the computer arrangement comprising processing means and a memory.

In order to generate a 3D impression on a multi-view display device, images from different virtual view points have to be rendered. This requires either multiple input views or some 3D or depth information to be present. This depth information can be either recorded, generated from multiview camera systems or generated from conventional 2D video material. For generating depth information from 2D video several types of depth cues can be applied: such as structure from motion, focus information, geometric shapes and dynamic occlusion. The aim is to generate a dense depth map, i.e. per pixel a depth value. This depth map is subsequently used in rendering a multi-view image to give the viewer a depth impression. In the article “Synthesis of multi viewpoint images at non-intermediate positions” by P. A. Redert, E. A. Hendriks, and J. Biemond, in Proceedings of International Conference on Acoustics, Speech, and Signal Processing, Vol. IV, ISBN 0-8186-7919-0, pages 2749-2752, IEEE Computer Society, Los Alamitos, Calif., 1997 a method of extracting depth information and of rendering a multi-view image on basis of the input image and the depth map are disclosed.

It is an object of the invention to provide a method of the kind described in the opening paragraph, which is based on a new depth cue.

This object of the invention is achieved in that the method comprises:

segmenting the image into a first segment and a second segment;

assigning a first one of the depth values corresponding to a first one of the pixels of the first segment on basis of a first size of the first segment and assigning a second one of the depth values corresponding to a second one of pixels of the second segment on basis of a second size of the second segment whereby the first one of the depth values is less than the second one of the depth values if the first size is less than the second size.

The invention is based on the following observation. Objects have some two-dimensional size within an image, i.e. image segments which corresponds to respective objects in a scene, have a certain size. The probability that an object which is larger in two-dimensional sense occludes another object which is smaller in two-dimensional sense, is higher than vice versa. Therefore if a smaller object is in the background of a large object, it will not be visible. But if it is in the foreground it will be visible. Hence, small objects are more likely foreground objects. In other words, if the first size of a first segment corresponding to a first object is less than the second size of a second segment corresponding to a second object then the depth values for the first segment are lower than the depth values for the second segment. It should be noted that the background also forms one or more objects, e.g. the sky or a forest or a meadow.

It should be noted that another size related depth cue is known. That known depth cue is called “relative size cue” or “perspective cue”. However, that known depth cue is based on other assumption and results in opposite depth values. The “relative size cue” is based on the fact that objects which are further away are smaller, while in the depth cue according to the invention smaller objects are assumed to be closer to the viewer. The “relative size cue” is only applicable for comparing and assigning depth values to similar type of objects, e.g. two persons or two cars. The usage of the “relative size cue” requires a higher cognitive process to classify the image segments into objects of predefined types. An advantage of using the depth cue according to the invention is that this complicated type of classification is not needed.

A step in the method according to the invention is segmentation. Segmentation is a process of classifying pixels on basis of the pixel values and the coordinates of the pixels. The pixel values might represent color and/or luminance. Segmentation means that values are assigned to the pixels of an image, which are related to connectivity between pixels, i.e. are two pixels connected or not. There are several algorithms for segmentation, e.g. based on edge detection or on homogeneity computation.

With size is meant a one-dimensional or a two-dimensional geometrical quantity, e.g. length, height, width, area, perimeter, extreme radius, i.e. smallest or the biggest diameter of a circle which fits inside a contour of a segment or encloses the segment. Alternatively, the size is based on a combination of two of these quantities.

The depth value which is based on the computed size can be directly used as depth value for rendering a multi-view image, e.g. as described in the cited article. Preferably, the depth value according to the invention is combined with other depth values which are based on alternative depth cues as mentioned above.

In an embodiment of the method according to the invention, the first size is computed by determining a first number of neighboring pixels which are disposed on a line extending from a first side of the first segment to a second side of the first segment. The second size is computed in a similar way, i.e. by counting the number of pixels in one-dimension. An advantage of this computation is that it is relatively easy to implement.

In another embodiment of the method according to the invention the first size is computed by counting a second number of pixels which are disposed inside a contour which is located on an edge of the first segment. In other words, the area of the first segment is determined. All pixels of which is assumed that they belong to the first segment are accumulated. This computation is advantageous in the case that the segmentation is based on edge detection and where a clear edge between the first and second segment is found.

Unfortunately, for some images it is not possible to classify all pixels with an absolute certainty, i.e. there is a probability that a particular pixel belongs to the first segment but also that the particular pixel belongs to the second segment. For determining the size of the first segment this particular pixel could be taken into account but also for determining the size of the second segment this particular pixel could be taken into account. Hence, in an other embodiment of the method according to the invention the first size is computed by accumulating a set of probability values. The probability values represent probabilities that respective pixels belong to the first segment. Alternatively, the probability values represent probabilities that two pixels belong to the same segment. In a further alternative, a first one of the probability values is based on a further distance between the first one of the pixels of the first segment and a contour which is located on an edge of the first segment.

The computation of the size of the first segment, by taking into account the probability values, is based on a one-dimensional or two-dimensional group of pixels. For instance, the set of probability values corresponds to pixels disposed on a line extending from a first side of the first segment to a second side of the first segment.

It is a further object of the invention to provide a depth map generating unit of the kind described in the opening paragraph, which is based on a new depth cue.

This object of the invention is achieved in that the generating unit comprises:

segmentation means for segmenting the image into a first segment and a second segment;

assigning means for assigning a first one of the depth values corresponding to a first one of the pixels of the first segment on basis of a first size of the first segment and for assigning a second one of the depth values corresponding to a second one of pixels of the second segment on basis of a second size of the second segment whereby the first one of the depth values is less than the second one of the depth values if the first size is less than the second size.

It is a further object of the invention to provide an image processing apparatus comprising a depth map generating unit of the kind described in the opening paragraph which is arranged to generate a depth map based on a new depth cue.

This object of the invention is achieved in that the generating unit comprises:

segmentation means for segmenting the image into a first segment and a second segment;

assigning means for assigning a first one of the depth values corresponding to a first one of the pixels of the first segment on basis of a first size of the first segment and for assigning a second one of the depth values corresponding to a second one of pixels of the second segment on basis of a second size of the second segment whereby the first one of the depth values is less than the second one of the depth values if the first size is less than the second size.

It is a further object of the invention to provide a computer program product of the kind described in the opening paragraph, which is based on a new depth cue.

This object of the invention is achieved in that the computer program product, after being loaded, provides said processing means with the capability to carry out:

segmenting the image into a first segment and a second segment;

assigning a first one of the depth values corresponding to a first one of the pixels of the first segment on basis of a first size of the first segment and assigning a second one of the depth values corresponding to a second one of pixels of the second segment on basis of a second size of the second segment whereby the first one of the depth values is less than the second one of the depth values if the first size is less than the second size.

Modifications of the depth map generating unit and variations thereof may correspond to modifications and variations thereof of the image processing apparatus, the method and the computer program product, being described.

These and other aspects of the depth map generating unit, of the image processing apparatus, of the method and of the computer program product, according to the invention will become apparent from and will be elucidated with respect to the implementations and embodiments described hereinafter and with reference to the accompanying drawings, wherein:

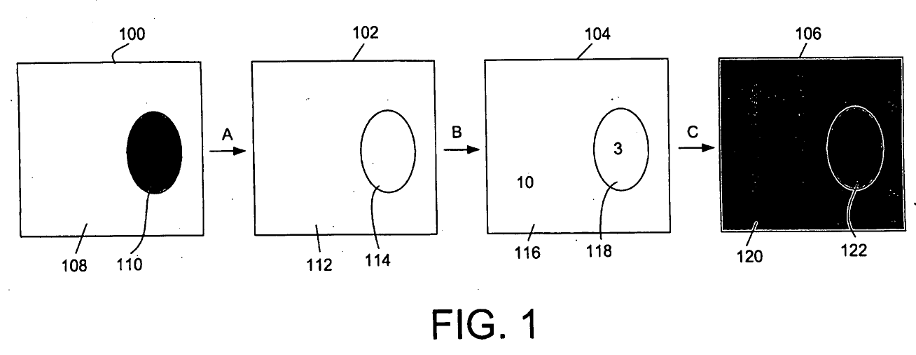

FIG. 1 schematically shows the method according to the invention;

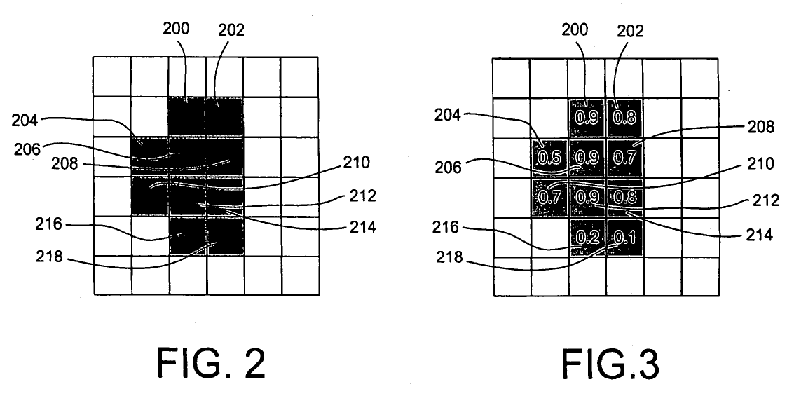

FIG. 2 schematically shows a number of pixels which belong to a particular segment;

FIG. 3 schematically shows the probability values of a number of pixels, representing the probability of belonging to a particular segment;

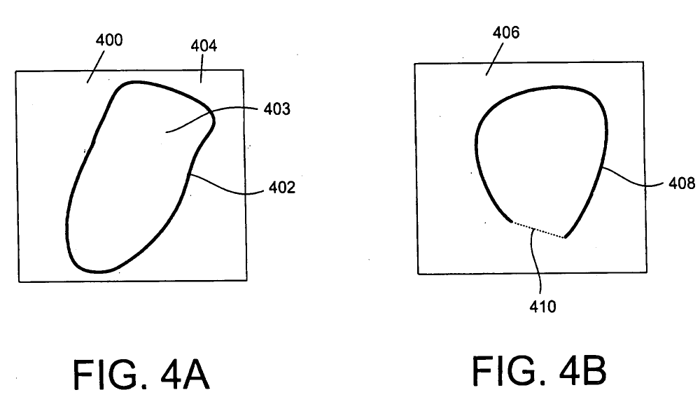

FIGS. 4A and 4B schematically show images and contours which are found on basis of edge detection in the images;

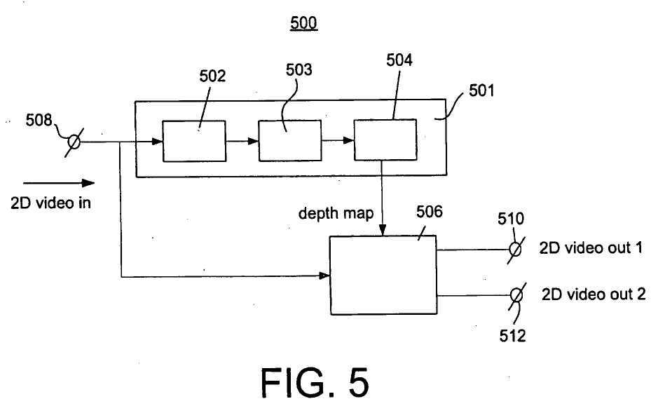

FIG. 5 schematically shows a multi-view image generation unit comprising a depth map generation unit according to the invention; and

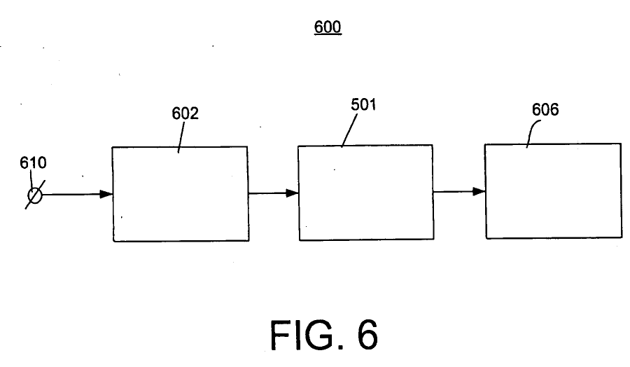

FIG. 6 schematically shows an embodiment of the image processing apparatus according to the invention.

Same reference numerals are used to denote similar parts throughout the figures.

FIG. 1 schematically shows the method according to the invention. FIG. 1 shows an image 100 representing a first object 110 and a second object 108 which is located behind the first object 110. A first step A of the method according to the invention is segmentation. The segmentation result 102 comprises a first segment 114, i.e. a first group of connected pixels and comprises a second segment 112, i.e. a second group of connected pixels. It will be clear that the first segment 114 corresponds to the first object 110 and that the second segment 112 corresponds to the second object 108. A second step B of the method according to the invention is establishing the sizes of the first segment 114 and the second segment 112. FIG. 1 shows an intermediate result 104 of the method according to the invention, i.e. a two-dimensional matrix 104 of values representing size, being computed for the segments 114 and 112. A first set of elements 118 of the two-dimensional matrix 104 has been assigned the size value 3. This first set of elements 118 corresponds to the first object 110. A second set of elements 116 of the two-dimensional matrix 104 has been assigned the size value 10. This second set of elements 116 corresponds to the second object 108. A third step C of the method according to the invention is determining the depth values. FIG. 1 shows a depth map 106. The depth map 106 comprises a first group of depth values 122 corresponding to the first object 110 and comprises a second group of depth values 120 corresponding to the second object 108. The depth values of the first group of depth values 122 are lower than the depth values of the second group of depth values 120, meaning that the first object 110 is more close to a viewer of the image 100 or to a multi-view image which is based on the image 100, than the second object 108.

FIG. 2 schematically shows a number of pixels 200-218 of an image, which belong to a particular segment. There are several ways for determining the size of the particular segment. A first way is based on counting the number of pixels on a horizontal line with minimum length. In this case this results in a size value which is equal to 2, e.g. by counting the 2 pixels which are indicated with reference numbers 200 and 202 or with 216 and 218. A second way is based on counting the number of pixels on a horizontal line with maximum length. In this case this results in a size value which is equal to 3, e.g. by counting the three pixels which are indicated with reference numbers 204-208 or with 210-214. A third way is based on counting the number of pixels on a vertical line with minimum length. In this case this results in a size value which is equal to 2, i.e. by counting the 2 pixels which are indicated with reference numbers 204 and 210. A fourth way is based on counting the number of pixels on a vertical line with maximum length. In this case this results in a size value which is equal to 4, e.g. by counting the 4 pixels which are indicated with reference numbers 200, 206, 212 and 216. Alternatively the size of the particular segment 114 is based on the product of a width and height, e.g. 3*4=12 or 2*4=8. A further alternative is based on counting the total number of pixels, indicated with reference numbers 200-218, resulting into the size value equal to 10.

FIG. 3 schematically shows the probability values of a number of pixels, representing the probability of belonging to the particular segment. Preferably, probability values are taken into account for determining the size of the particular segment. A first way for determining the size of the particular segment, by taking into account probability values, is based on integration or accumulation of probability values corresponding to pixels on a first horizontal line. For instance by accumulating the values 0.5, 0.9 and 0.7 corresponding to pixels which are indicated with reference numbers 204, 206 and 208, respectively. It will be clear that similar as described in connection with FIG. 2 there are several ways for determining the size of the particular segment. That means that other combinations of probability values corresponding to other pixels might be used.

FIGS. 4A and 4B schematically show images and contours which are found on basis of edge detection in the images. Detecting edges might be based on spatial high-pass filtering of individual images. However, the edges are preferably detected on basis of mutually comparing multiple images, in particular computing pixel value differences of subsequent images of the sequence of video images. A first example of the computation of pixel value differences E(x,y,n) is given in Equation 1:

E(x,y,n)=|I(x,y,n)−I(x,y,n−1)| (1)

with, I(x,y,n) the luminance value of a pixel with coordinates x and y of image at time n. Alternatively, the pixel value differences E(x,y,n) are computed on basis of color values:

E(x,y,n)=|C(x,y,n)−C(x,y,n−1)|(2)

with, C(x,y,n) a color value of a pixel with coordinates x and y of image at time n. In Equation 3 a further alternative is given for the computation of pixel value differences E(x,y,n) based on the three different color components R (Red) G (Green) and B (Blue).

E(x,y,n)=max(|R(x,y,n)−R(x,y,n−1)|,|G(x,y,n)−G(x,y,n−1)|,|B(x,y,n)−B(x,y,n−1)|) (3)

Optionally, the pixel value difference signal \vec{E} is filtered by clipping all pixel value differences which are below a predetermined threshold, to a constant e.g. zero. Optionally, a morphologic filter operation is applied to remove all spatially small edges. Morphologic filters are common nonlinear image processing units. See for instance the article “Low-level image processing by max-min filters” by P. W. Verbeek, H. A. Vrooman and L. J. van Vliet, in “Signal Processing”, vol. 15, no. 3, pp. 249-258, 1988.

Edge detection might also be based motion vector fields. That means that regions in motion vector fields having a relatively large motion vector contrast are detected. These regions correspond with edges in the corresponding image. Optionally the edge detection unit is also provided with pixel values, i.e. color and or luminance values of the video images. Motion vector fields are e.g. provided by a motion estimation unit as specified in the article “True-Motion Estimation with 3-D Recursive Search Block Matching” by G. de Haan et. al. in IEEE Transactions on circuits and systems for video technology, vol. 3, no. 5, October 1993, pages 368-379.

FIG. 4A shows an image 400 in which a closed contour 402 is drawn. This contour is located on an edge of a first segment, i.e. on the border between the first segment and a second segment. In the case of a closed contour it is relatively easy to determine which pixels belong to the first segment and which pixels do not belong to the first segment. The group of pixels 403 which are inside the contour 402 belong to the first segment. The other group of pixels 404 which are located outside the contour 402 do not belong to the first segment. In the case of a closed contour the ways of size computation as described in connection with FIG. 2 can be applied straightforward.

FIG. 4B shows an image 406 in which an open contour 408 is drawn. This contour is located on an edge of the first segment, i.e. on the border between the first segment and a second segment. Unfortunately, there is not a distinct edge between the group of pixels which are assumed to belong to the first segment and another group of pixels which are assumed not to belong to the first segment. Hence, in the case of an open contour it is not straightforward to determine which pixels belong to the first segment and which do not belong to the first segment. An option to deal with this issue is closing the contour which is found on basis of edge detection, by connecting to endpoints of the open contour. In FIG. 4 this is indicated with a line segment with reference number 410. Alternatively, to each of the pixel values a probability value is assigned which represents the probability of belonging to a particular segment, e.g. the first segment. On basis of these probability values it is possible to determine the size of segments as is explained in connection with FIG. 3.

FIG. 5 schematically shows a multi-view image generation unit 500 comprising a depth map generation unit 501 according to the invention. The multi-view image generation unit 500 is arranged to generate a sequence of multi-view images on basis of a sequence of video images. The multi-view image generation unit 500 is provided with a stream of video images at the input connector 508 and provides two correlated streams of video images at the output connectors 510 and 512, respectively. These two correlated streams of video images are to be provided to a multi-view display device which is arranged to visualize a first series of views on basis of the first one of the correlated streams of video images and to visualize a second series of views on basis of the second one of the correlated streams of video images. If a user, i.e. viewer, observes the first series of views by his left eye and the second series of views by his right eye he notices a 3D impression. It might be that the first one of the correlated streams of video images corresponds to the sequence of video images as received and that the second one of, the correlated streams of video images is rendered on basis of the sequence of video images as received. Preferably, both streams of video images are rendered on basis of the sequence of video images image as received. The rendering is e.g. as described in the article “Synthesis of multi viewpoint images at non-intermediate positions” by P. A. Redert, E. A. Hendriks, and J. Biemond, in Proceedings of International Conference on Acoustics, Speech, and Signal Processing, Vol. IV, ISBN 0-8186-7919-0, pages 2749-2752, IEEE Computer Society, Los Alamitos, Calif., 1997. Alternatively, the rendering is as described in “High-quality images from 2.5D video”, by R. P. Berretty and F. E. Ernst, in Proceedings Eurographics, Granada, 2003, Short Note 124.

The multi-view image generation unit 500 comprises:

a depth map generation unit 501 for generating depth maps for the respective input images on basis of detected edges; and

a rendering unit 506 for rendering the multi-view images on basis of the input images and the respective depth maps, which are provided by the depth map generation unit 501.

The depth map generating unit 501 for generating depth maps comprising depth values representing distances to a viewer, for respective pixels of the images, comprises:
an edge detection unit 502 for detecting edges in input images. The edge detection unit 502 is arranged to detect edges on basis of one of the algorithms as described in connection with FIG. 4A.

a segment size computation unit 503 for computing the size of the various segments being found on basis of the detected edges. The segment size computation unit 503 is arranged to compute segment sizes on basis of one of the algorithms as described in connection with FIG. 2 or FIG. 3; and

a depth value assigning unit 504 for assigning depth values corresponding to pixels on basis of the detected segment sizes.

The assigning of depth values is such that pixels which belong to a relatively small segment will be assigned relatively low depth values. A relatively low depth value means that the corresponding pixel is relatively close to the viewer of the multi view image being generated by the multi-view image generation unit 500.

The pixels of a particular segment can be assigned mutually equal size values, each representing the computed segment size. Alternatively, the pixels of a particular segment have different size values. A parameter controlling the assigned size value for a particular pixel is related to the probability that the particular pixel belongs to the segment. For instance, if the probability that the particular pixel belongs to a relatively small segment is relatively high, then the size value is relatively low. An alternative parameter for controlling the assigned size value for a particular pixel is related to a distance between the particular pixel and the contour. For instance, if the average distance between the particular pixel and the pixels located on the contour is relatively high, then the probability that the particular pixel belongs to the segment is also relatively high. The segment size computation unit 503 is arranged to provide a size signal S_{F}=S(x,y,n), with coordinates x and y of image at time n, which represents per pixel the size of the segment to which it belongs.

After the computation of the size signal S_{F} the depth map is determined. This is specified in Equation 4:

D(x,y,n)=F(S_{F}(x,y,n)) (4)

with D(x,y,n) the depth value of a pixel with coordinates x and y of image at time n and the function F(j) being a linear or non-linear transformation of a size value S_{F}(x,y,n) into a depth value D(x,y,n). This function F(j) might be a simple multiplication of the size value S_{F}(x,y,n) with a predetermined constant:

D(x,y,n)=α·S_{F}(x,y,n) (5)

Alternatively, the function F(j) corresponds to a multiplication of the size value S_{F}(x,y,n) with a weighting factor W(i). This weighting factor W(i) is preferably related to a spatial distance i between the pixel under consideration and a second pixel in a spatial neighborhood of the pixel under consideration, having a local maximum value. It is assumed that the second pixel is located in the center of the segment.

D(x′,y′,n)=W(x,y,x′,y′)*S_{F}(x,y,n) (6)

The edge detection unit 502, the segment size computation unit 503, the depth value assigning unit 504 and the rendering unit 506 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

It should be noted that, although the multi-view image generation unit 500 as described in connection with FIG. 5 is designed to deal with video images, alternative embodiments of the depth map generation unit according to the invention are arranged to generate depth maps on basis of individual images, i.e. still pictures.

FIG. 6 schematically shows an embodiment of the image processing apparatus 600 according to the invention, comprising:

a receiving unit 602 for receiving a video signal representing input images;

a multi-view image generation unit 501 for generating multi-view images on basis of the received input images, as described in connection with FIG. 5; and

a multi-view display device 606 for displaying the multi-view images as provided by the multi-view image generation unit 501.

The video signal may be a broadcast signal received via an antenna or cable but may also be a signal from a storage device like a VCR (Video Cassette Recorder) or Digital Versatile Disk (DVD). The signal is provided at the input connector 610. The image processing apparatus 600 might e.g. be a TV. Alternatively the image processing apparatus 600 does not comprise the optional display device but provides the output images to an apparatus that does comprise a display device 606. Then the image processing apparatus 600 might be e.g. a set top box, a satellite-tuner, a VCR player, a DVD player or recorder. Optionally the image processing apparatus 600 comprises storage means, like a hard-disk or means for storage on removable media, e.g. optical disks. The image processing apparatus 600 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware. The usage of the words first, second and third, etcetera do not indicate any ordering. These words are to be interpreted as names.

1. A method of generating a depth map (106) comprising depth values representing distances to a viewer, for respective pixels of an image (100), the method comprising:
segmenting the image (100) into a first segment (110) and a second segment (108); and
assigning a first one of the depth values corresponding to a first one of the pixels of the first segment (110) on basis of a first size of the first segment (110) and assigning a second one of the depth values corresponding to a second one of pixels of the second segment (108) on basis of a second size of the second segment (108) whereby the first one of the depth values is less than the second one of the depth values if the first size is less than the second size.

2. A method as claimed in claim 1, whereby the first size is computed by determining a first number of neighboring pixels (204-208) which are disposed on a line extending from a first side of the first segment (110) to a second side of the first segment (110).

3. A method as claimed in claim 1, whereby the first size is computed by counting a second number of pixels (200-218) which are disposed inside a contour which is located on an edge of the first segment (110).

4. A method as claimed in claim 1, whereby the first size is computed by accumulating a set of probability values.

5. A method as claimed in claim 4, whereby the probability values represent probabilities that respective pixels belong to the first segment (110).

6. A method as claimed in claim 5, whereby the set corresponds to pixels disposed on a line extending from a first side of the first segment (110) to a second side of the first segment (110).

7. A method as claimed in claim 4, whereby the probability values represent probabilities that the first one of pixels and a third one of the pixels belong to the first segment (110).

8. A method as claimed in claim 4, whereby a first one of the probability values is based on a further distance between the first one of the pixels of the first segment (110) and a contour which is located on an edge of the first segment (110).

9. A depth map generating unit (501) for generating a depth map (106) comprising depth values representing distances to a viewer, for respective pixels of an image (100), the generating unit comprising:
segmentation means (502) for segmenting the image (100) into a first segment (110) and a second segment (108); and
assigning means (504) for assigning a first one of the depth values corresponding to a first one of the pixels of the first segment (110) on basis of a first size of the first segment (110) and for assigning a second one of the depth values corresponding to a second one of pixels of the second segment (108) on basis of a second size of the second segment (108) whereby the first one of the depth values is less than the second one of the depth values if the first size is less than the second size.

10. An image processing apparatus (600) comprising:
receiving means (602) for receiving a signal corresponding to an image (100); and
a depth map generating unit (501) for generating a depth map (106), as claimed in claim 1.

11. A computer program product to be loaded by a computer arrangement, comprising instructions to generate a depth map (106) comprising depth values representing distances to a viewer, for respective pixels of an image (100), the computer arrangement comprising processing means and a memory, the computer program product, after being loaded, providing said processing means with the capability to carry out:
segmenting the image (100) into a first segment (110) and a second segment (108); and
assigning a first one of the depth values corresponding to a first one of the pixels of the first segment (110) on basis of a first size of the first segment (110) and assigning a second one of the depth values corresponding to a second one of pixels of the second segment (108) on basis of a second size of the second segment (1108) whereby the first one of the depth values is less than the second one of the depth values if the first size is less than the second size.
